(19) United States
(12) Patent Application Publication
(10) Pub. No.: US 2013/0151523 A1
(43) Pub. Date: Jun. 13, 2013

(54) PHOTO MANAGEMENT SYSTEM

(71) Applicant: Chen-Ning Hsi, Taipei (TW)

(72) Inventor: Chen-Ning Hsi, Taipei (TW)

(73) Assignee: PRIMAX ELECTRONICS LTD., Taipei (TW)

(21) Appl. No.: 13/437,633

(22) Filed: Apr. 2, 2012

(30) Foreign Application Priority Data
Dec. 9, 2011 (TW) 100145597

(51) Int. Cl. G06F 17/30

(52) U.S. Cl. 707/737; 707/736; 707/E17.026

(57) ABSTRACT

A photo management system is provided to record occurrence dates of important events in the individual life course, classify the photos according to the occurrence dates and name the photo folders. Once the preset occurrence date of a specified event is approaching, the photo management system will remind the user of taking and storing photos. Consequently, the photo management system provides a photo book marked by individual life timing. Another photo management system is a family relationship-based photo management system for managing family relationship and sharing photos. By linking the birth date to the blood relation, linking the marriage date to the affinity relation and using the information of the face address book, the kinship between the user and others can be established to deduce the family tree.

### FIELD OF THE INVENTION

The present invention relates to a photo management system, and more particularly to a human-centered photo management system.

### BACKGROUND OF THE INVENTION

A photo-recording method is an important way for recording the daily activities, making friends or making contact with good friends in the modern societies. As a variety of electronic devices and cost-effective storage devices are gradually developed, most electronic devices have image-capturing functions for allowing the users to take photos at any time and wherever they are.

Generally, in a case the user has many electronic devices with the function of storing photos or shooting photos, it is difficult to transmit the photos between various storage devices and manage these photos. Recently, as the concepts of the cloud computing technology have been emerged, the photos can be uploaded to and stored in a cloud server. The cloud service providers may also provide an easy method for helping the users manage the photos. However, the preset classification items or the simply approach of setting the classification items by the user are usually unsatisfied. In addition, the cloud service providers have not offered the services of sharing the photos which are stored in a lot of electronic devices or storage devices owned by the user. In other words, there is no proper customized photo management system for moving and managing the photos of the user.

Moreover, if a user wants to share photos to good friends and family, the shared photos may be unsuccessfully received or opened by the electronic device of the receiver. In other words, the conventional photo sharing method is troublesome to the sharer or the receiver, and thus the pleasure of sharing photos will be alleviated.

Therefore, there is a need of providing an improved photo management system for managing and sharing photos in order to obviate the drawbacks encountered from the prior art.

### SUMMARY OF THE INVENTION

The present invention provides a photo management system. A photo sharing browser is installed in an electronic device of a customer (i.e. a user). The photo management system is included in the photo sharing browser. The photo management system has a photo management module for establishing the photo architecture according to important events of the individual life course. That is, the photo management system is a life course-based photo management system.

The present invention further provides a photo management system for managing photos according to the family relationship, thereby sharing photos among the relatives of a family.

The present invention further provides a photo management system with a photo management module. The photo management module may manage photos according to a face address book and the life course, thereby quickly classifying the photos.

The present invention further provides a photo management system for creating a lineal kinship relation-relevant data table. According to the lineal kinship relation-relevant data table, the kinship relation between an individual and others and a family tree are deduced, so that a family relationship-based photo management system is achieved.

The present invention further provides a photo management system capable of issuing a recommendation notice. Since the recommendation notice contains a title of a relative, the recommendation notice is more user-friendly to recommend the user to act.

In accordance with an aspect of the present invention, there is provided a photo management system for recording an individual life course. The photo management system includes a date recording module, a life course segmentation module, and a photo classification module. The date recording module is used for recording occurrence dates of a plurality of events about a user. The life course segmentation module is used for segmenting the life course of the user into a plurality of life stages. The photo classification module is used for classifying a plurality of photos into the plurality of life stages.

In an embodiment, the occurrence dates of the plurality of events at least includes a birth date, a school admission date, a graduation date, a marriage date and a retirement date, wherein the occurrence dates of the plurality of events are past dates or expected dates in the future, or the occurrence dates of the plurality of events include past dates and expected dates in the future.

In an embodiment, according to the occurrence date of at least one specified event, the date recording module further deduces the occurrence dates of the other events, wherein the deduced occurrence dates of at least two events are collectively defined as a life stage.

In an embodiment, the occurrence dates of at least two events are collectively defined as one of the life stages.

In an embodiment, the plurality of photos are classified into the plurality of life stages by the photo classification module according to a metadata of each photo, wherein the metadata includes a shooting date of the corresponding photo.

In an embodiment, photo management system further includes a date modification module for allowing the user to modify the occurrence date of the at least one event.

In an embodiment, according to a recognizing result about image contents of each photo, the photo is classified into a corresponding life stage by the photo classification module.

In an embodiment, the recognizing result denotes a result of whether an image of a specified person is located at a specified position of the photo.

In an embodiment, the recognizing result denotes a result of whether an image of a specified article is included in the photo.

In an embodiment, the photo management system further includes a recommendation module for generating a recommendation notice.

In an embodiment, the recommendation module generates the recommendation notice when the occurrence date of a corresponding event is approaching, or the recommendation module generates the recommendation notice when a specified occurrence date deduced according to the occurrence date of at least one event is approaching.

In an embodiment, the recommendation notice is an action suggestion, and the action suggestion is related to a life stage corresponding to a date of generating the recommendation notice.

In an embodiment, the recommendation notice contains a content of remaindering the user of taking photos.

In an embodiment, photo management system further includes a folder management module for storing the photos of each life stage into a corresponding photo folder.

In an embodiment, the photo folder is named according to the life stage corresponding to the photos included in the photo folder.

In an embodiment, the photo management system further includes a life course playback module for playing photos included in the photo folder according to selection of the user.

In accordance with another aspect of the present invention, there is provided a family relationship-based photo management system. The family relationship-based photo management system includes a face address book creating module, a family relationship creating module, and a photo management module. The face address book creating module is used for creating a face address book of a target customer. The family relationship creating module is used for deducing at least one kinship relation of the target customer according to the face address book. The photo management module is used for generating a recommendation notice according to the face address book and the kinship relation, wherein the recommendation notice contains a title of a relative of the target customer.

In an embodiment, the face address book creating module further creates a lineal kinship relation-relevant data table about the target customer.

In an embodiment, the family relationship creating module further deduces a kinship relation of the target customer according to the face address book and the lineal kinship relation-relevant data table of the target customer, or the family relationship creating module further deduces a kinship relation of the target customer by recognizing image contents of at least one photo containing a plurality of persons.

In an embodiment, the lineal kinship relation-relevant data table contains a father-relevant data, a mother-relevant data, a child-relevant data, and a spouse-relevant data.

In an embodiment, the father-relevant data of the lineal kinship relation-relevant data table about the target customer contains a birth date of the target customer and a first code corresponding to Father of the target customer in the face address book. The mother-relevant data contains the birth date of the target customer and a second code corresponding to Mother of the target customer in the face address book. The child-relevant data contains a birth date of a child of the target customer and a third code corresponding to the child of the target customer in the face address book. In addition, the spouse-relevant data contains a marriage date of the target customer and a spouse thereof and a fourth code corresponding to the spouse of the target customer in the face address book.

In an embodiment, the family relationship creating module further generates a family tree of the target customer according to the at least one kinship relation of the target customer.

In an embodiment, the face address book includes information about a face image of at least one contact person, a relationship between the contact person and the target customer, and a code of the at least one contact person.

In an embodiment, the face address book creating module further create a lineal kinship relation-relevant data table about the target customer and a lineal kinship relation-relevant data table about each contact person in the face address book.

In an embodiment, the family relationship creating module further generates a family tree of the target customer according to the face address book, the lineal kinship relation-relevant data table of the target customer and the lineal kinship relation-relevant data table of the at least one contact person.

In an embodiment, the lineal kinship relation-relevant data table contains a father-relevant data, a mother-relevant data, a child-relevant data, and a spouse-relevant data.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates an application example of a photo management system according to an embodiment of the present invention;

FIG. 2 is a schematic functional block diagram illustrating the architecture of a photo management system according to a first embodiment of the present invention;

FIG. 3 is a schematic functional block diagram illustrating the architecture of a photo management system according to a second embodiment of the present invention;

FIG. 4 schematically illustrates the architecture of a lineal kinship relation-relevant data table used in the family relationship-based photo management system of the present invention; and

FIG. 5 schematically illustrates a family tree generated by the family relationship-based photo management system of the present invention.

### DETAILED DESCRIPTION OF THE PREFERRED EMBODIMENT

Digital photo metadata, which is also known as metadata (or data in data or data about data), basically comprises the information about the camera model, the processing software, the shooting time, the camera aperture, the ISO value, and so on. In this context, the above items of the metadata are also referred as basic metadata. The commercially available digital camera or the shooting handheld electronic device with a shooting function may use the shooting time of the metadata to classify the photos according to the month of shooting the photos. In comparison with the conventional technology, the photo management system of the present invention can manage photos in a more life-related and experience-related manner.

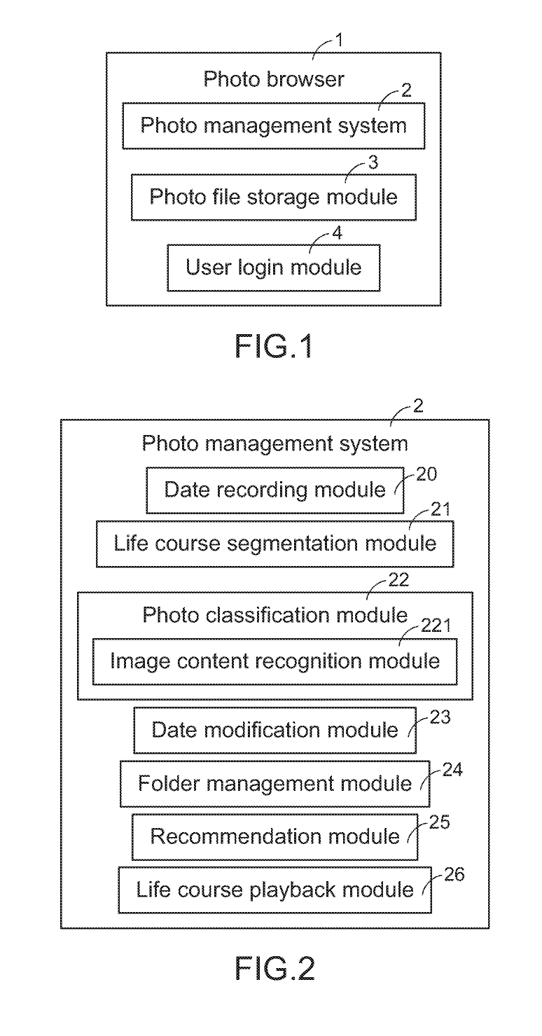

FIG. 1 schematically illustrates an application example of a photo management system according to an embodiment of the present invention. The photo management system is applied to an electronic device with a shooting function. This electronic device has a photo browser for allowing the user to directly view the photos through the electronic device. As shown in FIG. 1, the photo management system is a life course-based photo management system for recording the individual life course of the user. The photo browser 1 comprises the photo management system 2 and a photo file storage module 3. The photo file storage module 3 is usually used for storing the data of the photos captured by the electronic device and the corresponding metadata. The photo management system 2 is used for managing the photos stored in the photo file storage module 3. Moreover, the photo management system 2 of the present invention may be implemented by software (e.g. an application program). In addition, the photo management system 2 of the present invention may be applied to a network environment, and implemented in a photo management platform under a cloud environment.

It is noted that the photo management system 2 of the present invention may be used by any person who operates the electronic device. For example, the photo browser 1 further comprises a user login module 4. For using the photo management system 2, a login step should be performed. After the login step is successfully done, the photo management system 2 can be used by the login user to manage photos. Even if the same electronic device is operated by a plurality of users, the photo management system 2 can perform individual photo management according to the login information. Alternatively, in some other embodiments, when the electronic device is in communication with a cloud server through the internet and the user account for the cloud server is authenticated, the photo management system 2 can be used to perform the individual photo management of the electronic device and the cloud server. After the user account for the cloud server is authenticated, the photos stored in a plurality of electronic devices may be synchronously managed by the photo management system 2. Since the way of managing photos is related to the life course of the login user, the user no longer needs to take much time to manually manage and name the photos in the photo folders.

FIG. 2 is a schematic functional block diagram illustrating the architecture of a photo management system according to a first embodiment of the present invention. As shown in FIG. 2, the photo management system 2 at least comprises a date recording module 20, a life course segmentation module 21, and a photo classification module 22. In an embodiment, the date recording module 20 is used for recording the occurrence dates of a plurality of events about the user. Generally, from the birth to the death, there are many important events for an individual life course. These events include for example a birth event, a pre-school event, a school event, a graduation event, an inauguration event, a marriage event, a retirement event, and so on. That is, the date recording module 20 is used for recording the occurrence dates of these events, and outputting the occurrence dates of these events to the life course segmentation module 21. According to the occurrence dates of these events, the life course of the user may be segmented into a plurality of life stages by the life course segmentation module 21.

Moreover, the occurrence dates of the events about the user may be recoded and inputted into the date recording module 20 by the user. For example, as shown in FIGS. 1 and 2, after the electronic device with the photo browser 1 is turned on and the photo browser 1 is activated, the user may create a login account through the user login module 4. During the process of creating the login account, the date recording module 20 may ask the user to input the occurrence dates of several events such as a birth date, a school admission date, a graduation date, a marriage date, a retirement date, and so on. The above dates may be past dates or anticipated or expected dates in the future. In addition, the above dates may be simultaneously or successively inputted by the user. In another embodiment, the occurrence dates of the events may be preset according to some statistic data (for example but are not limited to a national average education level, a national average school-admission age, a marriage age, a retirement age, and so on). In a case that the above dates are not inputted by the user, the date recording module 20 may further comprise an event deduction module (not shown) for presetting or deducing the occurrence dates of several events. For example, the birth date plus six years may be deduced as the school admission date, and the school admission date plus nine years may be deduced as the graduation date.

As previously described, the date recording module 20 can record the occurrence dates of the above events. In addition, the date recording module 20 may further have the function of adjusting or updating the dates. For example, during the process of creating the login account, the user may simply input the birth date of the user. According to the inputted birth date, the date recording module 20 will preset the occurrence dates of the other events. After the login account is created, if the photo management system 2 is used by the user, the user may input the birth date again or the photo management system 2 will issue a request notification signal to the user. Alternatively, after the request notification signal is received by the user, the user may issue a replying signal. In response to the replying signal, the occurrence dates of these events will be updated. Moreover, the date recording module 20 also provides a function of allowing the user to add or delete the occurrence dates of the above events. For example, if the retirement date is not needed, the retirement date may be deleted through the date recording module 20. Moreover, the photo management system 2 may further comprise a date modification module 23 for allowing the user to modify the occurrence dates of the above events. Alternatively, in some embodiments, the date modification module 23 may be integrated into the date recording module 20.

Moreover, after the occurrence dates of the plurality of events from the date recording module 20 are received by the life course segmentation module 21, the occurrence dates of at least two events are collectively defined as a plurality of life stages by the life course segmentation module 21. For example, the birth date and the school admission date of the user may be collectively defined as a pre-school life stage. In accordance with a key feature of the present invention, the life course segmentation module 21 is used for defining at least two events as a plurality of life stages. Moreover, these life stages may be named in a more life-related manner. For example, these life stages may be named as a pre-school life stage, a school life stage, or the like. The names of these life stages may be used in photo management, which will be illustrated later.

From the above discussions, the life course segmentation module 21 is used for segmenting the life course of the user into the plurality of life stages, and the photo classification module 22 is used for classifying a plurality of photos into the plurality of life stages. Please refer to FIGS. 1 and 2 again. The photo file storage module 3 is used for storing the photos which are captured by the electronic device. That is, the data of the photos and corresponding metadata are stored in the photo file storage module 3. Generally, the stored metadata of the captured photo include at least a shooting time. In the first embodiment, the plurality of photos are classified into the plurality of life stages by the life course segmentation module 21 according to the metadata of each photo stored in the photo file storage module 3. For example, after a shooting date of the metadata of any photo is received by the life course segmentation module 21, according to the time period of a corresponding life stage covering the shooting date, the life course segmentation module 21 will classify the photo corresponding to the metadata into the specified life stage.

In addition to the function of classifying any photo into a corresponding life stage according to the basic metadata of the photo, the photo management system 2 of the present invention is capable of recognizing photos by other means. Please refer to FIGS. 1 and 2 again. In addition to the function of storing the basic metadata of each photo, the photo classification module 22 further comprises an image content recognition module 221 for recognizing the image contents of each photo. According to a recognizing result about the image contents of each photo, the photo is classified into a corresponding life stage by the photo classification module 22. For example, if the graduation date is not inputted by the user during the process of creating login account, the photo management system 2 will preset the occurrence date of the graduation event and the school life stage. After the image content of a new photo is recognized by the image content recognition module 221 of the photo classification module 22, if the face image indicates that the user with a graduation cap is located at the central position of the photo, the photo classification module 22 will preset the shooting date of this photo as the graduation date according to the recognizing result and classify this photo into the school life stage. In addition, the photo management system 2 may issue a request notification signal to the user to confirm whether the preset conditions are correct. In response to the feedback signal of the user, the photo management system 2 may adjust the graduation date and the corresponding life stage and further adjust the classification of the photo. From the above discussions, the photo classification module 22 may classify a photo into a corresponding life stage according to a recognizing result of the photo by the image content recognition module 221. For example, the recognizing result denotes a result of whether an image of a specified person is located at a specified position of the photo. Alternatively, the recognizing result denotes a result of whether an image of a specified article is included in the photo.

Moreover, the photo management system 2 further comprises a folder management module 24. The folder management module 24 is used for storing the photos of each life stage into a corresponding photo folder. The name of the photo folder created by the folder management module 24 is derived from the name of the life stage, which is defined by the life course segmentation module 21. That is, the name of the photo folder created by the folder management module 24 includes the name of the life stage containing the corresponding photos. For example, the photo folder may be named as a “pre-school” photo folder. Moreover, the photo folders created by the folder management module 24 may be applied to the photo file storage module 3 of FIG. 1 in order to store photo files. Moreover, the photo file storage module 3 may be integrated into the photo management system 2. Alternatively, the folder management module 24 may be integrated into the photo file storage module 3. It is noted that integration of the above modules is presented herein for purpose of illustration and description only.

In such way, the photo management system 2 of the present invention is capable of automatically classifying photos into corresponding photo folders without the need of manually classifying the photos. Moreover, since the photo folder is named according to the name of the corresponding life stage (i.e. the photo folder is not named as arbitrary serial numbers or month), the name of the photo folder is related to the life course for facilitating the user to judge the contents of the photos stored in the photo folder.

From the above discussions, the photo management system 2 can provide a humanized reminder to the login user according to the occurrence dates of the event created by the date recording module 20. In the first embodiment, the photo management system 2 further comprises a recommendation module 25 for generating a recommendation notice. Especially, the recommendation module 25 generates the recommendation notice at the time when the occurrence date of each event is approaching. For example, after the photo browser 1 is opened by the login user, the photo management system 2 will compare a system time of the electronic device with the occurrence date of each event. Once the system time approaches the occurrence date of a specified event, the photo management system 2 will issue the recommendation notice to remind the user that the life stage close to the occurrence date of the specified event is coming. For example, the recommendation notice may contain the content of remaindering the user that the school stage will be finished and the graduation date is coming. By viewing the recommendation notice, the user may be remaindered to take more photos of the school stages. Alternatively, in some embodiments, the recommendation module 25 generates the recommendation notice according to the birth date and the well-known knowledge about the human development. For example, according to the birth date, some important time spots (e.g. the time of starting to crawl, the time of starting to grow teeth) in the pre-school stage may be deduced. In addition, once the above time spots are approaching, the recommendation notice will be issued to remind the user of taking photos. That is, the recommendation module 25 of the photo management system 2 generates the recommendation notice at the time when the occurrence date of each event is approaching. An example of the recommendation notice is an action suggestion. The action suggestion is related to the life stage corresponding to the date of generating the recommendation notice. For example, the recommendation notice may contain the content of remaindering the user of taking photos. Due to the recommendation notice, the user will not miss taking photos at every important life stage while leaving the recallable photos. Alternatively, the recommendation module 25 of the photo management system 2 generates the recommendation notice when a specified occurrence date deduced according to the occurrence date of at least one event is approaching.

From the above discussions, the photo management system 2 may generate the recommendation notice according to the manually inputted or well-known knowledge about the human development. Moreover, the photo management system 2 may extract derived knowledge according to the native knowledge and the contents of the photos and may further generate the recommendation notice according to the derived knowledge. The derived knowledge may be used to deduce the stage of establishing the relationship between one person and other persons and may superimpose the stage of establishing the relationship with the above-mentioned life stages. For example, the photo management system 2 may deduce the derived knowledge about the interactive relationship between the user and the classmates thereof according to the individual school stage and the contents of the photos, and further generate the recommendation notice to remind the user of taking group photos with the classmates. In addition, the photo management system 2 may deduce the stage of establishing the loving or parting relationship between the user and others according to the contents of the photos, adjust the reminder content about the recommendation notice, and further process the classification items of the photo folder to be confirmed by the user.

Moreover, the photo management system 2 may further comprise a life course playback module 26. After the photos are automatically classified and stored into the life stage folders by the photo management system 2, the life course playback module 26 may play the photos included in a specified photo folder according to the user's selection. For example, if the photos in the pre-school stage are selected, the life course playback module 26 will automatically play the photos of the pre-school photo folder.

From the above discussions, the photo management system 2 of the present invention may manage individual photos by described various stages of individual life course in a user-friendly manner. The photo management system 2 can be applied to the photo management of a single electronic device. Moreover, the photo management system 2 may cooperate with a cloud server to manage all photos stored in different electronic devices. In addition, since all photos related to the user may be automatically classified according to the life stages of the user, it is time-saving to manage photos. Since all classified photo folders are named by the photo management system 2 according to the life stages, the user can clearly realize which photo folder stores the photos of a specified life stages. In such way, the time period of naming the photo folders is saving and the photos are not repeatedly stored. Moreover, by recording the occurrence dates of the events, the photo management system 2 of the present invention is capable of generating the recommendation notice at suitable time, thereby reminding the user of taking photos and leaving the recallable photos of the life course.

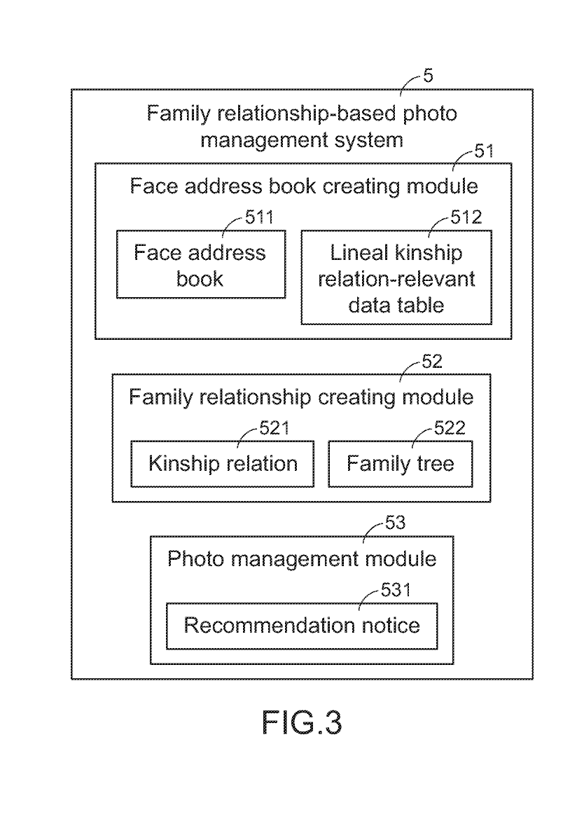

From the above discussions, the photo management system 2 of the present invention is capable of recording the occurrence dates of some important events in order to leave the photo record of the individual life course. More especially, the photo management system 2 of the present invention is capable of recording the life course of establishing relationship and interaction between the user and other persons. The relationship between the user and other persons includes for example a blood relation, an affinity relation, a classmate relation or a friend relation. The blood relation and the affinity relation are collectively defined as a kinship relation, which is closely related to the family. Hereinafter, the architecture of a photo management system according to a second embodiment of the present invention will be illustrated by referring to FIG. 3. It is noted that similar functions of the photo management system of the first embodiment may be integrated into the photo management system of the second embodiment. In addition, the similar functions may be respectively included in different photo management systems.

FIG. 3 is a schematic functional block diagram illustrating the architecture of a photo management system according to a second embodiment of the present invention. As shown in FIG. 3, the photo management system 5 is a family relationship-based photo management system. The family relationship-based photo management system 5 comprises a face address book creating module 51, a family relationship creating module 52, and a photo management module 53. The face address book creating module 51 is used for creating a face address book 511 of a target customer. The family relationship creating module 52 is used for deducing at least one kinship relation 521 of the target customer according to the face address book 511. The photo management module 53 is used for generating a recommendation notice 531 according to the face address book 511 and the kinship relation 521, wherein the recommendation notice 531 contains a title of a relative of the target customer.

In the second embodiment, the family relationship-based photo management system 5 may facilitate managing the photos according to the family face images. When a target custom with the logic account accesses the family relationship-based photo management system 5, the face address book creating module 51 may be utilized to create the face address book 511. The face address book 511 includes the information about the face image of any contact person, the name of any contact person, the relationship between the contact person and the target customer, a telephone number, and other name-related contact data. Moreover, the face address book creating module 51 may assign a code to each contact person. In addition to the function of creating the face address book 511, the face address book creating module 51 further has a function of creating a lineal kinship relation-relevant data table 512. The lineal kinship relation-relevant data table 512 and the face address book 511 may be separately stored. Alternatively, the lineal kinship relation-relevant data table 512 may be integrated into the face address book 511. Alternatively, the lineal kinship relation-relevant data table 512 is correlated with an item of the face address book 511. In addition to the function of creating the lineal kinship relation-relevant data table 512 of the target customer, the face address book creating module 51 further a function of creating and storing the lineal kinship relation-relevant data of each contact person of the face address book 511 into the lineal kinship relation-relevant data table 512.

Moreover, the face address book 511 of the target customer may be manually created by the target customer. For example, any face image of the photo stored in the electronic device or other sites may be added to the face image of the face address book 511 by a cursor-dragging operation through an input device (e.g. a mouse). If no face image is included in the face image of the face address book 511, the face image of the photo will be added to the face image of the face address book 511. Whereas, if a face image is intended to be added to any existing face image, the face address book creating module 51 will compare the face image with the existing face image and inquire the target customer whether the face image and the existing face image are the images of the same person. Alternatively, the face address book creating module 51 may issue a prompt message to inform the user whether the existing face image is replaced. After the cursor-dragging operations are successively performed, the whole face address book 511 is created. As mentioned above, the face address book 511 may be manually created. Moreover, after the new photos with face images are received by the family relationship-based photo management system 5, if the family relationship-based photo management system 5 recognizes and judges that the face image is not included in the face address book 551 according to the face images, the face address book creating module 51 will generate a new contact person creating prompt for informing the target customer whether the new photo needs to be immediately processed or not.

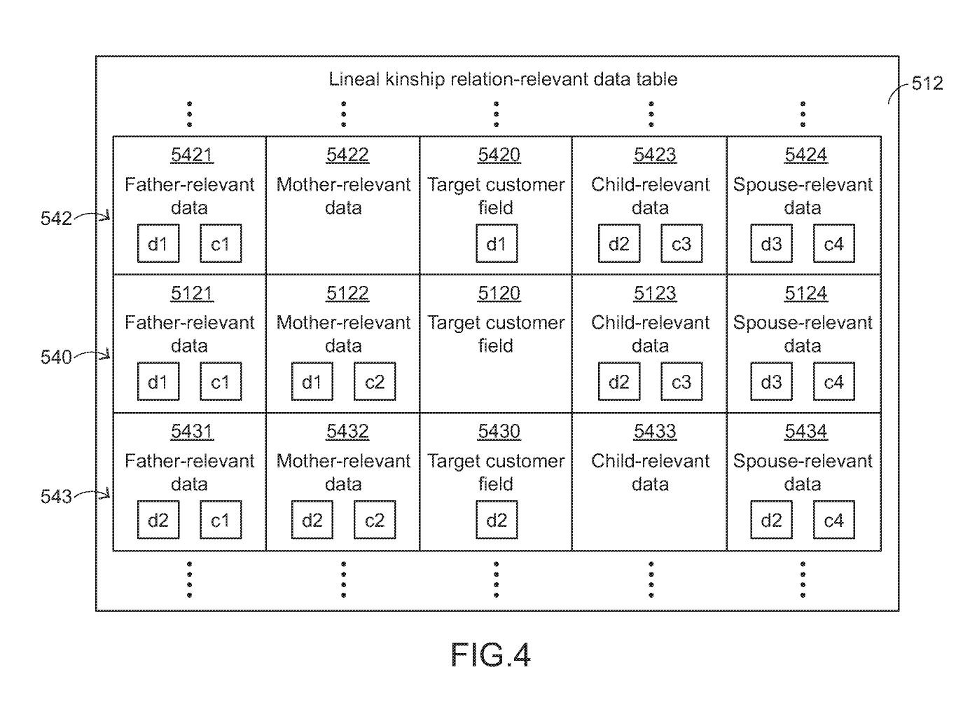

FIG. 4 schematically illustrates the architecture of a lineal kinship relation-relevant data table used in the family relationship-based photo management system of the present invention. The family relationship creating module 52 is used for deducing a kinship relation 521 of the target customer according to the face address book 511 and the lineal kinship relation-relevant data table 512. In this embodiment, the contact persons included on the face address book 511 of the target customer may include for example the parents, the siblings, the friends and the spouse of the target person. Moreover, the face address book creating module 51 preset several fields for each target customer in order to create the lineal kinship relation-relevant data table 512 of the corresponding target customer. The lineal kinship relation-relevant data table 512 comprises a target customer row 540. The target customer row 540 comprises a target customer field 5120, a father-relevant data 5121, a mother-relevant data 5122, a child-relevant data 5123, and a spouse-relevant data 5124. The relevant data corresponding to the target customer field 5120 of the lineal kinship relation-relevant data table 512 contains a relative code of a corresponding relative. For example, the messages stored in the father-relevant data 5121 contain the birth date d1 of the target customer and a first code c1 corresponding to the father of the target customer in the face address book 511. The messages stored in the mother-relevant data 5122 contain the birth date d1 of the target customer and a second code c2 corresponding to the mother of the target customer in the face address book 511. The messages stored in the child-relevant data 5123 contain the birth date d2 of the child and a third code c3 corresponding to the child of the target customer in the face address book 511. The messages stored in the spouse-relevant data 5124 contain the marriage date d3 of the target customer and the spouse thereof and a fourth code c4 corresponding to the spouse of the target customer in the face address book 511. In a case that the target customer is not married or the target customer has no child, the corresponding fields of the target customer in the lineal kinship relation-relevant data table 512 may be reserved. Moreover, the target customer field 5120 may be a reserved field, which may be a blank field or may include the birth date d1 of the target customer. Moreover, in addition to the above fields, the number of fields included in the lineal kinship relation-relevant data table 512 may be expanded according to the practical requirements in order to subsequently store other relevant data. Moreover, if the target customer has a plurality of children, the child-relevant data 5123 may include a plurality of fields to store other child-relevant data. From the above discussions, each filed of the lineal kinship relation-relevant data table 512 contains the information of establishing the lineal kinship relation between the target customer and the relative (e.g. the date of establishing the lineal kinship relation) and the code of the relative. In other words, the date of establishing the lineal kinship relation between the target customer and the parents thereof is the birth date of the target customer; the date of establishing the lineal kinship relation between the target customer and the spouse thereof is the marriage date of the target customer and the spouse thereof; and the date of establishing the lineal kinship relation between the target customer and the child thereof is the birth date of the child.

In addition to the function of utilizing the face address book 511 and the lineal kinship relation-relevant data table 512, the family relationship creating module 52 is capable of recognizing a plurality of individual face images contained in at least one photo, thereby deducing a kinship relation of the target customer and allowing the kinship relation to be confirmed by the target customer. For example, if a group photo containing a plurality of face images is received by the family relationship-based photo management system, the group photo may be determined as a family photo by recognizing the face images according to an image recognition technology. Consequently, the face image not included in the face address book can be acquired, and then confirmed by the target customer.

From the above discussions, the family relationship creating module 52 can deduce the kinship relation 521 of the target customer according to the face address book 511 and the lineal kinship relation-relevant data table 512. For example, during the face address book 511 is established by the target customer, the face image, the target customer may only input the name and the telephone number of the target customer's father but dose not input the kinship relation between the target customer and the father thereof. From now on, if the target customer wants to share a photo to the father thereof or the photo has been analyzed by the family relationship-based photo management system 5, a request notification signal is issued. After the request notification signal is confirmed by the target customer, the deduced father-child kinship relation between the target customer's father and the target customer is confirmed. The lineal kinship relation-relevant data table 512 may also be applied to the photo management module 53. According to the face address book 511 and the kinship relation 521, the photo management module 53 may generate a recommendation notice 531, wherein the recommendation notice 531 contains a title of a relative of the target customer. For example, after the photo is searched and analyzed by the family relationship-based photo management system 5 (for example according to an image recognition technology), if a contact person (e.g. the target customer's father) of the face address book 511 has a small number of photos, the photo management module 53 may generate a recommendation notice 531 to remind the target customer to take father's photos. In this embodiment, the name of the contact person is not contained in the contents of the recommendation notice 531 to be viewed by the target customer, but the contents of the recommendation notice 531 to be viewed by the target customer contain the title of the contact person (e.g. “Father”) to remind the target customer. Since the titles of the relatives are provided to remind the target customer, the family relationship-based photo management system 5 of the present invention can provide a more user-friendly interpersonal relationship. It is noted that the contents of the recommendation notice 531 may be related to different target customers. Under this circumstance, if the contents of the recommendation notice 531 remind the target customer to take more photos of the father thereof, the term “Father” is related to different contact persons.

Moreover, the photo management module 53 may further gather statistics and perform analysis on the frequency of generating the group photos including the target customer and a specified relative, thereby judging the relationship between the target customer and the specified relative is intimate or estranged. Consequently, at the suitable time spot, the photo management module 53 issues the recommendation notice or generates corresponding statistics data to the target customer. Moreover, the photo management module 53 may gather statistics on the non-kinship relation or the affinity relation between the target customer and others, and deduce whether the relation between them is changed, thereby adaptively managing the photo folders. Moreover, the photo management module 53 may further generate a recommendation notice according to the classification and package of the associated photo folders, and provide the recommendation notice to be confirmed by the target customer. Alternatively, the photo management module 53 may generate statistics data associated with the photos to the target customer, and may further generate a recommendation notice according to the statistics data in order to remind the target customer that the relationship is warmed up or terminated.

In addition to the above reminders, the recommendation notice 531 may further contain other contents such as the consumption suggestion or the photo sharing suggestion. As a consequence, the family relationship-based photo management system 5 of the present invention may be combined with some commercial marketing activities, and issue a proper recommendation notice to the target customer at a suitable time spot. After the recommendation notice is received by the target customer, the target customer may utilize the content of the recommendation notice (e.g. a web link) to link to a shopping web, thereby selecting desired commodities. In other words, the family relationship-based photo management system 5 of the present invention can provide not only the photo-managing function but also the value-added function.

Moreover, during the process of classifying the photos of the target customer, the above relative titles may be applied to name the photo folders. Under this circumstance, it is not necessary to type the names of the photo folders one by one or step by step. The family relationship-based photo management system 5 may directly establish and name the corresponding photo folders according to the relative titles. In a case that the photos are classified according to face image recognition, the photos of the contact persons may be directly stored in the photo folders of corresponding contact persons according to the recognizing result. Consequently, the photos can be quickly classified, and the photo folders can be intuitively named.

In addition to the lineal kinship relation-relevant data of the target customer, the lineal kinship relation-relevant data table 512 may further contain the lineal kinship relation-relevant data table about each contact person of the face address book 511. The fields of the lineal kinship relation-relevant data table of each contact person coincide with the fields of the lineal kinship relation-relevant data table of the target customer. That is, the lineal kinship relation-relevant data table of each contact person contains a father-relevant data, a mother-relevant data, a child-relevant data, and a spouse-relevant data. It is noted that the relative title (e.g. “Father” or “Mother”) included in the lineal kinship relation-relevant data table 512 is the title of the relative with respect to the target customer. That is, the relative title included in the lineal kinship relation-relevant data table 512 is not the title of the relative with respect to the contact person. For example, if the contact person is the spouse of the target customer, the father-relevant data in the lineal kinship relation-relevant data table contains the date of establishing the kinship relation between the target customer's father and the target customer's spouse and the code of the target customer's father. In other words, the date stored in this field denotes the marriage date of the target customer and the spouse thereof.

Please refer to FIG. 4 again. The mother row 542 includes a father-relevant data 5421, a mother-relevant data 5422, a target customer field 5420, a child-relevant data 5423, and a spouse-relevant data 5424. The child row 543 includes a father-relevant data 5431, a mother-relevant data 5432, a target customer field 5430, a child-relevant data 5433, and a spouse-relevant data 5434. The titles with respect to the target customer are shown in the above fields. The tilts are presented herein for purpose of illustration and description only. That is, other tilts may be shown on the above fields. For example, the messages stored in the father-relevant data 5420 of the mother row 542 contain the birth date d1 of the target customer and the first code c1 corresponding to the father of the target customer in the face address book 511. The messages stored in the target customer field 5420 contain the birth date d1 of the target customer or further contain the code (not shown) of the target customer. The messages stored in the child-relevant data 5423 contain the birth date d2 of the child and the third code c3 corresponding to the child of the target customer in the face address book 511. The messages stored in the spouse-relevant data 5424 contains the marriage date d3 of the target customer and the spouse thereof and the fourth code c4 corresponding to the spouse of the target customer in the face address book 511.

Similarly, the messages stored in the father-relevant data 5431 of the child row 543 contains the birth date d2 of the child and the first code c1 corresponding to the father of the target customer in the face address book 511. The messages stored in the mother-relevant data 5432 contains the birth date d2 of the child and the second code c2 corresponding to the mother of the target customer in the face address book 511. The messages stored in the target customer field 5430 contain the birth date d2 of the child. The messages stored in the spouse-relevant data 5434 the birth date d2 of the child and the fourth code c4 corresponding to the spouse of the target customer in the face address book 511. Alternatively, in some embodiments, the family relationship creating module 52 may generate and deduce the kinship relation between any two relatives of the target customer according to the face address book 511, the lineal kinship relation-relevant data table 512 of the target customer and the lineal kinship relation-relevant data table 512 of at least one contact person. For example, the kinship relation between the father of the target customer and the spouse of the target customer may be deduced as a relationship between the father-in-law and the son-in-law or the relationship between the father-in-law and the daughter-in-law.

That is, the field of the target customer in the kinship relation 521 contains the information about the date of establishing the relationship between the target customer and the relative and the identification code of the relative. According to the identification code of the relative, the location of the relative in the kinship relation 521 can be acquired. That is, the date of establishing the kinship relation between the target customer and the father thereof is the birth date of the target customer. The date of establishing the kinship relation between the target customer and the mother thereof is the birth date of the target customer. The date of establishing the kinship relation between the target customer and the spouse thereof is the marriage date of the target customer and the spouse thereof. In addition, the date of establishing the kinship relation between the target customer and the child thereof is the birth date of the child. Then, according to the identification codes of respective relatives, the locations of the relatives in the kinship relation 521 will be acquired. From the above discussions, the information stored in the kinship relation 521 may be incomplete in the beginning However, from now on, the use of the family relationship-based photo management system 5 will inquire the target customer to fill in the relevant data, or deduce the relationship between the customer and a specified relative by acquiring the photo metadata or analyzing the contents of photos or according to the kinship relation. In addition, after a deducing result is generated, a request notice is issued to the target customer to inform the target customer of confirming the deducing result. In other words, the lineal kinship relation-relevant data table 512 may be written in a matrix data configuration. The lineal kinship relation-relevant data table 512 comprises the lineal kinship relation-relevant data of the target customer and the lineal kinship relation-relevant data of the contact persons in the face address book.

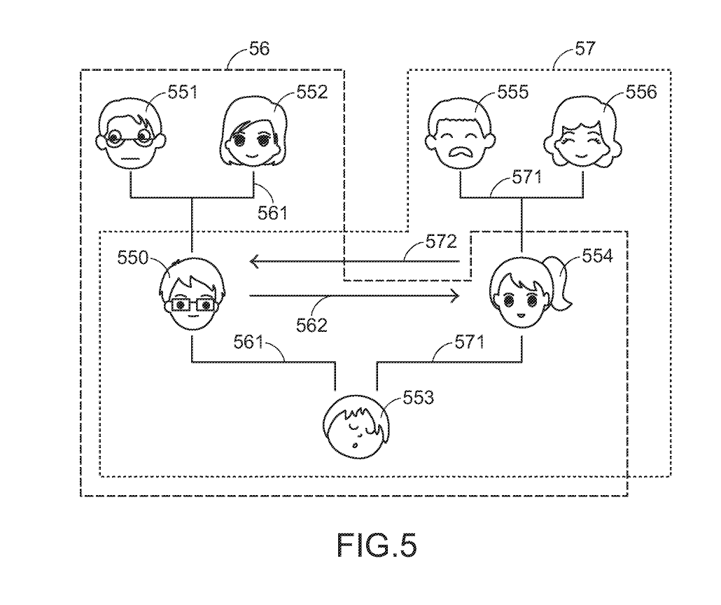

Moreover, according to at least one kinship relation of the target customer, the family relationship creating module 52 may generate a family tree 522 (see FIG. 3). FIG. 5 schematically illustrates a family tree generated by the family relationship-based photo management system of the present invention. As shown in FIG. 5, the family tree 56 of the target customer links the target customer's father 551, the target customer's mother 552, the target customer 550, the target customer's child 553 through the blood relation 561, and links the target customer's spouse 554 through the marriage relation 562. On the other hands, if the contact persons have respective login accounts and the lineal kinship relation-relevant data tables and the face address books or respective contact persons have been created, the family relationship creating module 52 may further create a family tree of the target customer according to the at least one kinship relation of the target customer and the lineal kinship relation-relevant data tables of these contact persons. Please refer to FIG. 5 again. The family tree 571 of the target customer's spouse links the father 555 of the target customer's spouse, the mother 556 of the target customer's spouse and the target customer's child 553 through the blood relation 571, and links the target customer 550 through the marriage relation 572. Consequently, if more family trees are included, the family tree of FIG. 5 becomes more complete. Moreover, the contents of the photos corresponding to several family trees may be mutually compared with each other. The comparing results will be issued to all members in the family tree. According to the comparing result, the photos of all members in the family tree will be replenished or confirmed, or all members in the family tree are reminded to exchange photos.

From the above discussions, the family relationship creating module 52 may generate the family tree of the target customer according to the kinship relation between the target customer and the contact person in the face address book. The family tree is similar to a pedigree system drawn in a general museum. From top to bottom, the family tree may include for example the father's generations of the target customer, the peer generations of the target customer, the junior generations of the target customer, and the like. Especially when the all members in the family tree have respective lineal kinship relation-relevant data table and agree to share data, the data and structure of the family tree become more complete. Moreover, according to an instruction of the target customer, the family relationship creating module 52 may generate a family tree of a specified relative. For example, only the family tree of the father's generation of the target customer or the family tree of the peer generation of the target customer is generated by the family relationship creating module 52.

From the above description, the photo management system is capable of managing individual photos according to the individual life course. Moreover, the photo management system is capable of managing the family photos according to the kinship relation, the relationship between the target customer and others (e.g. a loving relationship), the statistics data or the combination thereof. The above mechanisms may individually used or in combination with each other. The photo management system has many benefits. For example, the photo management system is able to efficiently manage photos in the human-centered or family relationship-based manner without the need of manually classifying photos by the user according to a specified purpose. Moreover, the way of recording and recognizing the face images may facilitate the user to manage the kinship relation of the user, so that the photos to be shared may be quickly shared to all or some specified members of the family. Moreover, due to the storage of the lineal kinship relation-relevant data table and the deduction of the family relationship creating module, the photo management system of the present invention is capable of sharing family relationship-based photos without the need of storing a large number of photo files or storing the family tree. Moreover, since the recommendation notice contains the relative title, the receiver is no longer called in the aloof appellation (e.g. the full name). In such way, the receiver is willing to receive the reminder of the recommendation notice and take actions according to the recommendation notice. In other words, the use of the photo management system of the present invention can achieve the functions of managing photos and promoting commercial marketing activities.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A photo management system for recording an individual life course, said photo management system comprising:
a date recording module for recording occurrence dates of a plurality of events about a user;
a life course segmentation module for segmenting said life course of said user into a plurality of life stages; and
a photo classification module for classifying a plurality of photos into said plurality of life stages.

2. The photo management system according to claim 1, wherein said occurrence dates of said plurality of events at least comprises a birth date, a school admission date, a graduation date, a marriage date and a retirement date, wherein said occurrence dates of said plurality of events are past dates or expected dates in the future, or said occurrence dates of said plurality of events include past dates and expected dates in the future.

3. The photo management system according to claim 1, wherein according to said occurrence date of at least one specified event, said date recording module further deduces said occurrence dates of the other events, wherein said deduced occurrence dates of at least two events are collectively defined as one of said life stages.

4. The photo management system according to claim 1, wherein said occurrence dates of at least two events are collectively defined as one of said life stages.

5. The photo management system according to claim 1, wherein said plurality of photos are classified into said plurality of life stages by said photo classification module according to a metadata of each photo, wherein said metadata includes a shooting date of said corresponding photo.

6. The photo management system according to claim 1, further comprising a date modification module for allowing said user to modify said occurrence date of said at least one event.

7. The photo management system according to claim 1, wherein according to a recognizing result about image contents of each photo, said photo is classified into a corresponding life stage by said photo classification module.

8. The photo management system according to claim 7, wherein said recognizing result denotes a result of whether an image of a specified person is located at a specified position of said photo.

9. The photo management system according to claim 7, wherein said recognizing result denotes a result of whether an image of a specified article is included in said photo.

10. The photo management system according to claim 1, further comprising a recommendation module for generating a recommendation notice.

11. The photo management system according to claim 10, wherein said recommendation module generates said recommendation notice when said occurrence date of a corresponding event is approaching, or said recommendation module generates said recommendation notice when a specified occurrence date deduced according to said occurrence date of at least one event is approaching.

12. The photo management system according to claim 11, wherein said recommendation notice is an action suggestion, and said action suggestion is related to a life stage corresponding to a date of generating said recommendation notice.

13. The photo management system according to claim 11, wherein said recommendation notice contains a content of remaindering said user of taking photos.

14. The photo management system according to claim 1, further comprising a folder management module for storing said photos of each life stage into a corresponding photo folder.

15. The photo management system according to claim 14, wherein said photo folder is named according to said life stage corresponding to said photos included in said photo folder.

16. The photo management system according to claim 14, further comprising a life course playback module for playing photos included in said photo folder according to selection of said user.

17. A family relationship-based photo management system, comprising:
a face address book creating module for creating a face address book of a target customer;
a family relationship creating module for deducing at least one kinship relation of said target customer according to said face address book; and
a photo management module for generating a recommendation notice according to said face address book and said kinship relation, wherein said recommendation notice contains a title of a relative of said target customer.

18. The family relationship-based photo management system according to claim 17, wherein said face address book creating module further creates a lineal kinship relation-relevant data table about said target customer.

19. The family relationship-based photo management system according to claim 18, wherein said family relationship creating module further deduces a kinship relation of said target customer according to said face address book and said lineal kinship relation-relevant data table of said target customer, or said family relationship creating module further deduces a kinship relation of said target customer by recognizing image contents of at least one photo containing a plurality of persons.

20. The family relationship-based photo management system according to claim 19, wherein said lineal kinship relation-relevant data table contains a father-relevant data, a mother-relevant data, a child-relevant data, and a spouse-relevant data.

21. The family relationship-based photo management system according to claim 20, wherein said father-relevant data of said lineal kinship relation-relevant data table about said target customer contains a birth date of said target customer and a first code corresponding to Father of said target customer in said face address book, said mother-relevant data contains said birth date of said target customer and a second code corresponding to Mother of said target customer in said face address book, said child-relevant data contains a birth date of a child of said target customer and a third code corresponding to said child of said target customer in said face address book, and said spouse-relevant data contains a marriage date of said target customer and a spouse thereof and a fourth code corresponding to said spouse of said target customer in said face address book.

22. The family relationship-based photo management system according to claim 17, wherein said family relationship creating module further generates a family tree of said target customer according to said at least one kinship relation of said target customer.

23. The family relationship-based photo management system according to claim 17, wherein said face address book includes information about a face image of at least one contact person, a relationship between said contact person and said target customer, and a code of said at least one contact person.

24. The family relationship-based photo management system according to claim 23, wherein said face address book creating module further create a lineal kinship relation-relevant data table about said target customer and a lineal kinship relation-relevant data table about each contact person in said face address book.

25. The family relationship-based photo management system according to claim 24, wherein said family relationship creating module further generates a family tree of said target customer according to said face address book, said lineal kinship relation-relevant data table of said target customer and said lineal kinship relation-relevant data table of said at least one contact person.

26. The family relationship-based photo management system according to claim 24, wherein said lineal kinship relation-relevant data table contains a father-relevant data, a mother-relevant data, a child-relevant data, and a spouse-relevant data.
